(19) United States
(12) Patent Application Publication
(10) Pub. No.: US 2011/0210149 A1
(43) Pub. Date: Sep. 1, 2011

(54) Flow Control Device For A Container For Fluids, and Actuator Element

(75) Inventor: Jan Essebaggers, Foster City, CA (US)

(73) Assignee: Enpros International B.V., Nieuwerkerk ad IJssel (NL)

(21) Appl. No.: 12/989,624

(22) PCT Filed: Apr. 24, 2009
(86) PCT No.: PCT/NL2009/050226

§ 371 Date: May 19, 2011

(30) Foreign Application Priority Data
Apr. 25, 2008 (NL) 2001524

(51) Int. Cl. B67D 7/06

(52) U.S. Cl. 222/544

(57) ABSTRACT

The invention relates to a flow control device (1) for a container (20) for fluids, wherein the flow control device is attachable to an opening of the container for fluids. The flow control device comprises a top cover section (2) with an outflow orifice (7), wherein a connection is formed between the container and the outflow orifice. The device is provided with a valve retaining element (5) with a through-flow orifice (8), and a movable valve (4) for alternately opening and closing the through-flow orifice. The flow control device comprises an actuator element (3), which is arranged to open the valve. A first chamber (11) and a second chamber (12) are formed in the flow control device, which are separated from one another by means of the actuator element. The actuator element is made to move in an upstream direction by an underpressure in the second chamber for bringing the valve into an opened position.

The invention relates to a flow control device for a fluid container, wherein the flow control device is attachable to an opening of the fluid container.

The invention further relates to an actuator element for application in a flow control device of the above kind.

A flow control device and actuator element of the above kind are known from EP 1.286.900. The known device relates to a drinking nozzle for attaching to, for example, a bottle or beverage container, wherein the bottle or beverage container can be filled with a fluid such as, for example, (carbonized) soft drinks. The known flow control device is provided with a flange on the opening of the bottle or drinking canister with a through-flow orifice and a valve. A spring ensures that the valve is retained in a closed position. This prevents a beverage contained in the container from flowing out. The known device also ensures that carbon dioxide contained in carbonized drinks is not lost. The flow control device is provided with a valve mechanism for opening the valve. The valve mechanism comprises two chambers, separated from one another by a flexible membrane. The flexible membrane is connected with a valve stem. Applying suction to the nozzle causes the pressure in one of the chambers to drop. The air pressure in the other chamber then ensures that the flexible membrane moves, so that the valve stem brings the valve into an opened position. This enables a user to drink the beverage contained in the container.

Because the valve mechanism is not always reliable, the flow control device is sometimes ineffective. The spring, for example, may press the valve too firmly against the through-flow orifice. Leakages may also occur in the membrane, which prevent the creation of underpressure required for the valve mechanism to open the valve. Consequently, the situation may arise that no fluid can flow from the container upon applying suction to the nozzle.

It is therefore an object of the invention to provide a solution to at least one of the aforementioned drawbacks.

To this end, the invention provides a flow control device of the type described in the foregoing, wherein the flow control device comprises a top cover section with an outflow orifice. A direct connection is formed between the container and the outflow orifice. In this way it is possible to allow fluid to flow out of the container via the outflow orifice. In this application, the direction in which the fluid flows in the aforementioned case will be designated as ‘downstream’. In an opposite direction, i.e. a flow from the outflow orifice to the interior of the container will be designated in this application as ‘upstream’. Upstream of the outflow-orifice, an attachable valve retaining element is provided on the opening of the container for fluids with a through-flow orifice. The flow control device is provided close to the through-flow orifice with a movable valve for alternately opening and closing the through-flow orifice. In this manner a flow control device is obtained which can be opened and closed, as desired. The valve is preferably arranged upstream of the through-flow orifice. Consequently, an overpressure in the container ensures that the valve remains in a closed position. The flow control device is preferably provided with a pre-tensioning means in order to retain the valve in a closed position. In this manner, a firm closure is obtained, regardless of the position of the container. For example, the container can be turned upside down, with the outflow orifice directed downwardly without causing fluid to flow out. The flow control device is provided with an actuator element, which is arranged to bring the valve into an opened position. The actuator preferably comprises a membrane. Preferably, a first chamber is formed between the top cover section and the actuator element. The first chamber preferably has an open connection with the outside air. As a result, atmospheric pressure prevails in the first chamber. A second chamber is preferably formed between the actuator element, the valve retaining element and the outflow orifice. The actuator element is preferably movable in an upstream direction as a result of an underpressure in the second chamber in order to bring the valve into an opened position. This is how a direct connection is formed between the inside of the container and the outflow orifice, so that fluid can flow from the container.

The outflow orifice of the top cover section is preferably provided with a tube element, extending in an upstream direction to an inner side of the top cover section. The tube element is preferably arranged parallel to a cylindrical form of the top cover section, such as for example a cylindrical drinking nozzle. The tube element extending towards the inside ensures that the inner side of the top cover section is not as easily accessible from the outside. In this manner, for example, the actuator element or the valve is less susceptible to damage, thus increasing the reliability of the flow control device.

The actuator element is preferably provided with a tube element, which extends in a downstream direction. On an inner shell of the tube element two sealing surfaces are arranged at an axial distance from one another. The sealing surfaces can be arranged on an outer shell of the tube element for attaching the actuator element to the top cover section. The sealing surfaces guarantee the air-tightness of the membrane, and ensure insulation between the first and the second chambers. Application of two sealing surfaces arranged at an axial distance from one another ensures that an additional barrier is formed in order to move air from the one chamber to the other. An embodiment as such increases the reliability of the flow control device.

When the membrane is damaged, pressure differences between the first chamber and the second chamber can no longer be achieved, and thus a correct operation of the flow control device is compromised. The tube element of the actuator element can be made attachable to an outer side of the tube element. As a result, the actuator element and, in particular the membrane, are then less easy accessible, via the outflow orifice. This reduces the risk of damage to the membrane. In this manner, the operation of the flow control device, and in particular the actuator element for controlling the valve, remains ensured. This increases the reliability of the flow control device. An embodiment as such also ensures that the actuator element can be easily attached to the top cover section, by sliding the tube element relatively easily over the tube element.

The sealing surfaces can be slidably attachable to the tube element. Because the sealing surfaces can slide over an outer shell of the tube element, the actuator element then has more freedom of movement in order to move the valve to an opened position.

It is possible that the sealing surface comprises a protuberance formed on an inner shell of the tube element. The protuberance may extend concentrically in the tube element. Here, the protuberances may have a rounded top. The protuberances may lie against the tube element of the top cover section, wherein the tube element is arranged substantially at a distance from the tube element. In this manner, the sealing surfaces ensure a good insulation between the first and the second chamber. In addition, the sealing surfaces produce relatively little frictional resistance upon moving or sliding the sealing surfaces over the tube element. As a result, the actuator element can be moved upwards and downwards quite easily, which ensures a relatively high reliability of the functionality of the flow control device.

The pre-tensioning means may comprise a spring. A spring is relatively cheap. A spring however, has the disadvantage that its resilience may change during the course of time. This may occur, for example, by exposure to heat, or because the spring is subjected to a load force in a deformable region. As a result, the spring can not close the valve sufficiently, which may result in leakage occurring.

In one advantageous embodiment, the actuator element is also the pre-tensioning means. The actuator element can be formed relatively rigid. The actuator element can also be designed in such a manner that sufficient force is exerted in order to press the valve onto the through-flow orifice of the valve retaining element. In this embodiment, relatively few parts are required, which makes the flow control device relatively cheap. Also, in this embodiment the resilience is guaranteed for a relatively long period of time. This increases the reliability and the durability of the device.

The pre-tensioning means may comprise a ridge formed near to an outermost edge of the membrane. The ridge ensures the resilience of the membrane. The resilience ensures that the membrane will want to return to an undeformed state when the membrane is deformed. As a result, it is relatively easy to keep the valve in a closed position when there is no underpressure is in the second chamber. The ridge may extend concentrically across the membrane. This increases the resilience of the membrane. It is possible that a top of the ridge extends in the direction of the first chamber. This also increases the resilience of the membrane in this embodiment.

The pre-tensioning means may comprise at least one protuberance extending in a radial direction from the membrane. The protuberance can be provided on an upper side of the membrane. The protuberance may run from an outer side of the membrane to the tube element. Here, the protuberance may be prismatic, the base of the prism being provided near to the tube element and wherein a top of the prism is provided near to the outermost edge of the membrane. Upon movement of the membrane in an axial direction, the radially arranged protuberances will deform. This will lead to stress in the protuberances. As a result of these stresses, the membrane will return to an undeformed state. This prevents any deformation from occurring. Therefore, the protuberances ensure that the membrane is made resilient. In this manner, sufficient force can be exerted to close the valve.

In one embodiment, at least two protuberances can be arranged on the membrane. The two protuberances can be provided opposite one another on an upper side of the membrane. The two protuberances can each be arranged at an angle of 180° in relation to another. In this manner, a stable resilience is obtained on the membrane. It is possible to apply multiple protuberances and also for each of those protuberances to be arranged at a regular angular distance from one other. In this way it is possible, for example, to apply 12 protuberances to the membrane. As a result, concentric parts of the membrane will move in a plane. This will then prevent the membrane from being out of line in the top cover section. This increases the reliability of the actuator element. The number of protuberances and the thickness of the protuberances define the resilience of the membrane, and can be defined in a manner known to those skilled in the art.

In one embodiment, the actuator element is integrally connected with the valve. ‘Integrally connected’ in the light of the invention means that the actuator element forms a direct connection with the valve at all times. Here, the valve can be connected to the actuator element by a relatively rigid connecting element. When the part of the actuator element to which the valve is attached moves, this movement ensures that the valve moves in conjunction therewith relatively simultaneously. A dependable operation of the flow control device is obtained because the membrane is in direct contact with the valve.

In one embodiment, the actuator element and the valve comprise a single integrated component. This embodiment ensures that the flow control device may comprise fewer parts. The valve in this embodiment is made from the same material as the actuator element. This ensures that the integrated component can be produced relatively cheaply. The actuator element and the valve can be made from a relatively flexible synthetic material. Here, the dimensions of the valve are such that the valve ensures that the through-flow orifice is properly sealed off.

The actuator element can be provided close to an outermost edge with hook means. These hook means can be arranged to act cooperatively with a rim provided on the flow control device. In this manner, it is possible to attach the actuator element to the top cover section. The hook means can be arranged in such a manner that the actuator element is disconnectably attachable to the flow control device. This ensures that the actuator element can be produced relatively cheaply. In this manner, an actuator element which no longer functions can be easily replaced.

In one embodiment, the hook means comprise a ridge formed on an outermost edge of the membrane. The ridge may extend concentrically across the actuator element. It is possible that a top of the ridge extends in the direction of the container for fluids. A ridge formed in this manner ensures a tight connection with the top cover section. As a result, a firm closure is obtained between the first and second pressure chamber. This increases the reliability of the flow control device.

The embodiment of the present invention will be described in more detail in the following figures. It will be clear to those skilled in the art that the invention is not limited to this embodiment, but that other equivalent measures are conceivable, without deviating from the scope of the invention. In the figures:

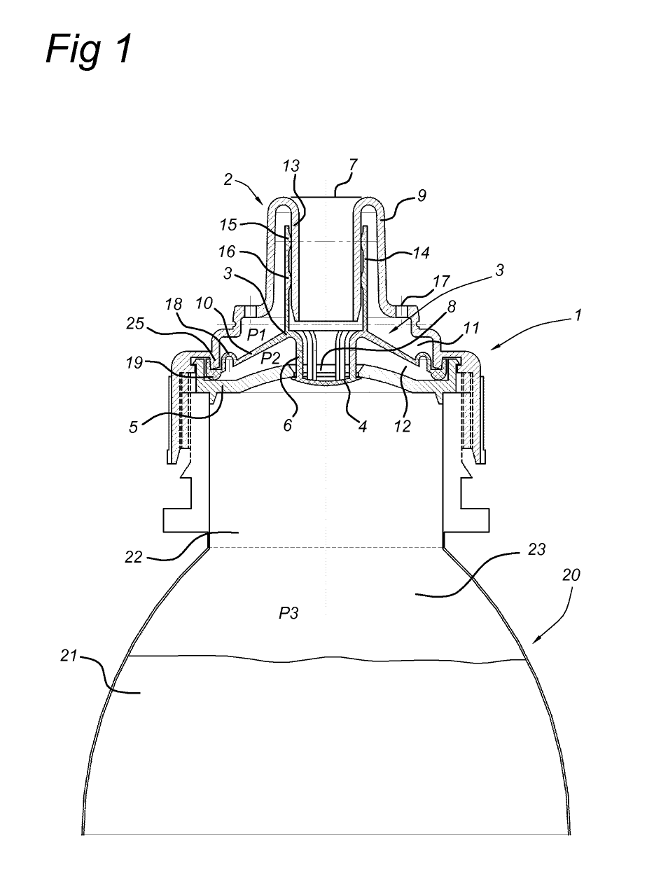

FIG. 1 shows a cross-sectional view of a flow control device according to the present invention;

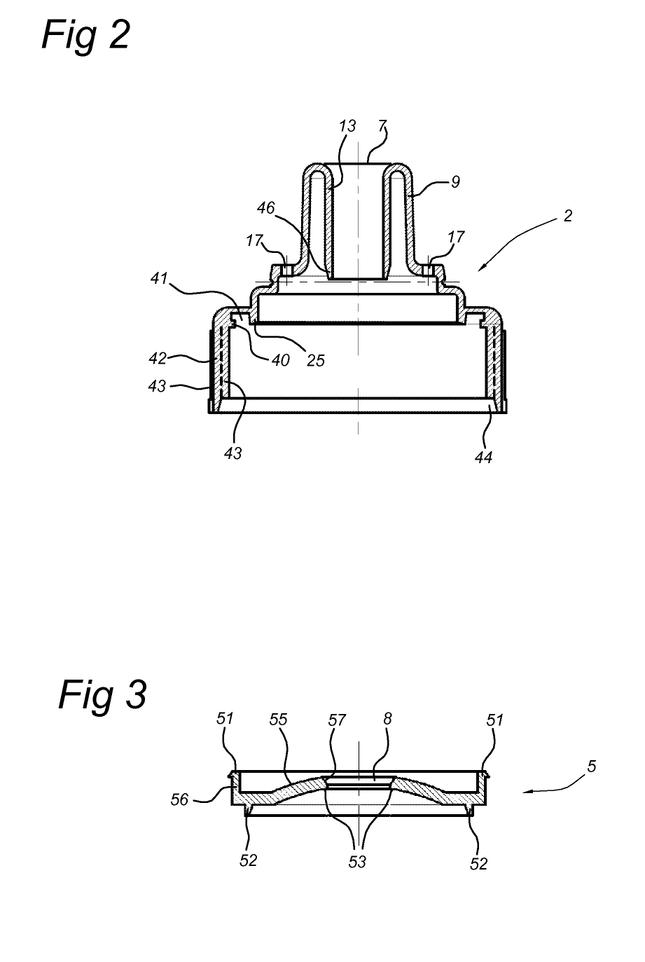

FIG. 2 shows a cross-sectional view of a top cover section for a flow control device;

FIG. 3 shows a cross-sectional view of a valve retaining element according to an embodiment of the present invention;

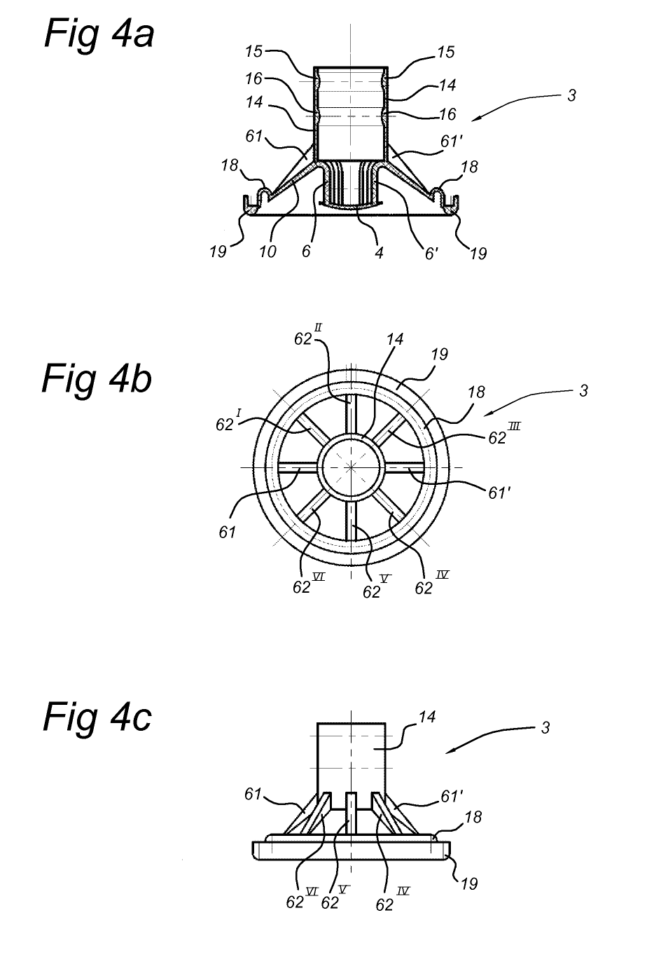

FIG. 4a-c show a cross-sectional view, a top view and a side view of an actuator element and a valve according to an embodiment of the present invention.

FIG. 1 shows a cross-section of a flow control device 1. The flow control device 1 is arranged on an orifice 22 of a container 20 for fluids 21. The container 20 comprises an internal volume 23. The flow control device 1 comprises a top cover section 2. Said top cover section can be formed from one piece of synthetic material. A drinking nozzle 9 with an outflow orifice 7 is provided on the valve section. Fluid 21 can flow from the internal volume 23 of the container to and out of the outflow orifice 7. This direction will be designated in this application as ‘downstream’. An opposite direction will be designated as ‘upstream’. A tube element 13 runs out of the outflow orifice 7 in an upstream direction. Accordingly, the tube element 13 extends to an interior of the top cover section 2. Upstream of the tube element 13 a valve retaining element 5 is arranged on the orifice 22 of the container for fluids. The valve retaining element is provided with a through-flow orifice 8. The through-flow orifice 8 forms a direct connection between the interior of the container 20 and the outflow orifice 7, so that the fluid can flow from the container to the outflow orifice 7. A movable valve 4 is arranged upstream of the through-flow orifice 8. The valve can move between a position wherein the through-flow orifice closes off, and a position wherein the through-flow orifice releases. In the figure shown, a pre-tensioning means 3 ensures that the valve 4 closes off the through-flow orifice 8. In the closed position, the valve rests upon the valve retaining element.

The flow control device 1 is further provided with an actuator element 3 with a flexible membrane 10. The actuator element is arranged to bring the valve into an opened position. The actuator element in the embodiment shown is integrally connected with the valve 4 by connecting means 6. Consequently, a flow control device is obtained which works with three components. However, it is also possible to have the actuator element not directly connected to the valve in order to obtain a 4-part design, for example, wherein the valve is integrally connected to the connecting means, and wherein the entire arrangement is connectable to the actuator element. In this manner the valve can be attached from the upstream side to the through-flow orifice. This enables the valve to be constructed quite rigidly. In addition, multipart arrangements, such as for example a 5-part design, are also conceivable, without deviating from the scope of the invention. In the 5-part design, the flow control device, for example, may be provided with an independent pre-tensioning element, such as for example a spring, which operates independently of the actuator.

In the embodiment shown, the actuator element is attached with a ridge 19 on an outermost side of the flow control device 1 on a raised edge 25. The membrane 10 gradually transforms near to a main shaft into a tube element 14. The tube element 14 extends in a downstream direction to the outflow orifice. Two sealing surfaces 15, 16 are mounted at an axial distance from one another on an inner shell of the tube element 14. In the embodiment shown, the sealing surfaces 15, 16 are provided with protuberances 15, 16 formed on an inner shell of the tube element 14, which extend concentrically into the tube element 14. The tube element 14 is mounted over the tube element 13, where the sealing surfaces 15, 16 rest upon an outer shell of the tube element 13. The sealing surfaces 15, 16 are slidably attached over the tube element 13.

In the flow control device 1 a first chamber 11 is formed between the top cover section 2 and the actuator element 3. In the top cover section 2 holes 17 are provided so that the first chamber forms an open connection with the outside air. Consequently, atmospheric pressure P1 may prevail in the first chamber. The top cover section, however, can be designed in such a manner, that a relatively constant pressure P1 is maintained in the first chamber, which is greater or lower than the atmospheric pressure. A second chamber is formed between the actuator element 3, the valve retaining element 5 and the outflow orifice 7. In the second chamber a pressure P2 may prevail. The pressure P2 of the second chamber can be adjusted independently of the pressure P1 in the first chamber. Pressure differences between the two chambers can be used to move the valve from a closed position to an open position, and vice versa.

The flow control device shown in FIG. 1 operates as follows. The actuator element 3 is mounted in the flow control device with some pre-tensioning force. Because the actuator element 3 is connected with the valve 4 by means of the connecting means 6, the valve 4 is pressed with some force against the through-flow orifice 8. Therefore, when not in use, the orifice 22 of the container 20 is closed off for fluids 21.

The actuator element can be arranged in order to control the valve as a result of pressure differences between the first and the second chamber. When a suction force is applied to the outflow orifice 7, the pressure P2 in the second chamber 12 will drop. Consequently, the pressure P2 in the second chamber 12 will be lower than the pressure P1 in the first chamber 11. This ensures that the membrane 10, together with the connecting means 6, will move downwardly. As a result, the valve 4 is pressed downwards so that the through-flow orifice 8 is brought into an opened position. This enables fluid to flow from the inside of the container 20 in the direction of the outflow orifice 7. It is possible that the pressure P3 in the container 20 becomes lower than the pressure P1 in the first room 11 by applying suction at the outflow orifice 7. As a result, the valve will remain in an opened position until the pressure P2 in the second chamber 12 is again equal to the pressure P1 in the first chamber 11. The actuator element 3 will then bring the valve 4 back into a closed position. When the pressure P3 in the container 20 is greater than the pressure P2 in the second chamber 12, the valve will be pushed in the direction of the second chamber 12. Consequently, the valve 3 will remain in a closed position and the fluid in the container will flow out of the container. If the fluid is a carbonized beverage, the carbon dioxide gas contained in the carbonized beverage cannot be released from the container. This means that the drink can be stored for longer periods without its taste being comprised.

The membrane 10 of the actuator element 3 must be capable of being moved in an upstream direction in order for the valve 4 to operate properly. For this to be achieved, the tube element 14 of the actuator element is mounted slidably on the tube element 13 of the top cover section 2. However, providing adequate sealing between the first chamber 11 and the second chamber 12 is essential to ensure the correct operation of the flow control device 1. This is why it is necessary for the movable tube element 15 to form an air-tight closure with the tube element 13. To ensure this, the two sealing surfaces 15, 16 are arranged at an axial distance from one another. In the embodiment shown, wherein the sealing surfaces comprise protuberances arranged concentrically on an inner shell of the tube element 15, the sealing surface ensures that the sealing between the two chambers is guaranteed. In addition, this embodiment ensures that there is relatively little friction when the membrane 10 moves up and down. As a result, the tube element 14 can move freely up and down when the valve 4 either opens or closes. As a result, the valve mechanism of the flow control device 1 remains dependable, thus ensuring its durability.

FIG. 2 shows a cross-sectional side view of a top cover section 2 according to the embodiment shown in FIG. 1. The corresponding elements of the top cover section shown in FIG. 1 have the same numerals as in FIG. 2. In the shown embodiment shown, the top cover section has a relatively wide cylindrical base 42 and tapers as it runs upwardly into the drinking nozzle 9 with outflow orifice. A tube element 13 extends to the inside from the outflow orifice 7. An end portion 46 of the tube element 13 runs slightly tapered, so that the tube element 14 of the actuator element 3 can be easily attached to the tube element 13.

On the inner side of the base 42, the top cover section 2 is provided with an internal screw thread 43. In this manner, the top cover section can be easily fastened to a corresponding external screw-thread of the fluid container. This ensures a proper sealing. An opening 44 tapers towards a lower side of the base 42. A radially extending flange 40 is located on an upper side of the screw-thread 43. An axially extending raised edge 25 is provided at a radial distance inwardly thereto. The raised edge 25, in conjunction with the flange 40, are arranged in such a manner that a space 41 is formed.

As can be seen in FIG. 1, the actuator element 3 and the valve retaining element 5 can be placed in the top cover section 2 via the opening 44. This is achieved by sliding the tube element 14 over the tube element 13. A ridge 19 of the actuator element can be formed on an outermost side on the raised edge 25. The valve retaining element 5 can then be arranged in such a manner that the space 41 is largely occupied by both the actuator element 3 and the valve retaining element 5. The flange 40 acts cooperatively with the valve retaining element 3 in order to hold it in place.

FIG. 3 shows a cross-sectional view of a valve retaining element 5, as shown in FIG. 1. In the embodiment shown, the valve retaining element 5 comprises an upwardly curved bottom 55 with a perimeter wall 56. A through-flow orifice 8 is provided in the bottom 55. The rims 57 of the through-flow orifice 8 taper in an upward direction. A valve seat 53 is located on a lower side of the through-flow orifice 8. On a lower side of the bottom 55 a raised edge 52 is provided which extends upstream, in an axial direction. The raised edge 52 can be a concentrically formed rim. A tapered flange 51 is provided on an upper side of the perimeter wall.

The curvature of the bottom 55 of the valve retaining element 5 ensures that the through-flow orifice 8 can be arranged relatively closer to the actuator element 3. The valve can also be arranged relatively close to actuator element 3. In this manner, the connecting means 6 shown in FIG. 1 may be formed relatively short.

The tapering rims 57 of the through-flow orifice 8 ensure that the valve 4 can align itself as it is pressed through through-flow orifice 8. This is particularly advantageous when assembling the flow control device. In addition, the tapering rims ensure that the fluid can flow easily into the second chamber 12. This is not impeded by the through-flow orifice in any way.

The dimensions of the raised edge 52 are chosen in such a manner that the valve retaining element 5 can be mounted relatively easily and in the correct manner to the orifice 22 of the container 20.

The flange 51 provided on the upper side of the perimeter wall 56 ensures the firm attachment of the valve retaining element 5 to the top cover section 2, as the flange slots into place behind the flange 40 shown in FIG. 2.

FIGS. 4a and 4b both show a cross-sectional view and a top view of an actuator element 3 shown in FIG. 1. The actuator element comprises a volcano-shaped base. The base is formed primarily by the flexible membrane 10. A ridge 19 is provided on an outer side of the actuator element. The ridge 19 can be used to place the actuator element on a rim 25 of the top cover section 2. The ridge 19 can be arranged in order to pre-tension the actuator element, such that the actuator element 3 pretensions the valve to a closed position. At a radial distance towards the inside, a spring means 18 is provided which is formed by an upwardly directed ridge. This spring means 18 may also be arranged to pre-tension the valve in a closed position. On an inner side, the membrane passes into the upwardly extending tube element 14, wherein the tube element 14 is provided with sealing surfaces 15, 16. The membrane passes downwardly into the connecting means 6, 6′ and then runs out into the valve 4. The connecting means 6, 6′ are arranged in such a manner that a direct connection is formed between the container and the outflow orifice when the valve 4 moves downwards.

In the embodiment shown, the actuator element 3, the connecting means 6, 6′ and the valve 4 are formed from a single integrated component, or, for example, from a resilient synthetic material. Because the component is made from a relatively resilient material, it is easy to place the component on the top cover section 2 in order to push the valve 4 through the through-flow orifice to position the valve upstream of the through-flow orifice. In addition, the flexible material is resilient enough to return the component to an undeformed state. This increases the reliability and the effective operation the flow control device 1.

As can be seen in FIG. 4b and FIG. 4c eight protuberances 61, 61′, 62 I, 62 II, 62 III, 62 IV, 62 V, 62 V are arranged at a regular angular distance from one another on the membrane. In the embodiment shown, a protuberance is a prism tapering into a point. The point is connected on an outer side to the membrane 10. The base of the prism is connected to the tube element 14. One side of the prism matches the membrane 10.

The present invention is not limited to the preferred embodiments thereof described herein. The requested rights are defined by the following claims within the scope of which numerous modifications are conceivable.

1. Flow control device (1) for a fluid container (20), wherein the flow control device (1) is attachable to an orifice (22) of the fluid container, wherein the flow control device comprises a top cover section (2) with an outflow orifice (7), wherein a direct connection is formable between the container and the outflow orifice, wherein the outflow orifice is provided with a tube element (13), which extends in an upstream direction to an inner side of the top cover section, wherein upstream of the tube element a valve retaining element (5) with a through-flow orifice (8) is provided, the retaining element (5) being mountable on the orifice of the fluid container, wherein the flow control device is provided with a movable valve (4) upstream of the through-flow orifice for the alternate opening and closing of the through-flow orifice, wherein the flow control device is provided with a pre-tensioning means (3) for keeping the valve in a closed position, wherein the flow control device comprises an actuator element (3) which is arranged to bring the valve into an opened position, wherein the actuator element is provided with a flexible membrane (10) and a tube element (14) extending in a downstream direction, the tube element having at least two sealing surfaces (15, 16) arranged at an axial distance from one another on an inner shell thereof, wherein said sealing surfaces are attachable to an outer shell of the tube element (13) for slidably connecting said actuator element, wherein a first chamber (11) is formed between the top cover section and the actuator element, the first chamber forming an open connection with the outside air via openings (17) formed in the top cover section, in such a manner that an atmospheric pressure prevails in the first chamber, and wherein a second chamber (12) is formed between said actuator element, said valve retaining element and said outflow orifice, wherein said actuator element is movable in an upstream direction by an underpressure in the second chamber with respect to the first chamber in order to bring the valve into an opened position.

2. Flow control device according to claim 1, wherein the actuator element (3) also is the pre-tensioning means (3).

3. Flow control device according to claim 2, wherein said pre-tensioning means comprises a ridge (18) near to an outermost edge of the membrane (10), wherein a top of the ridge extends in the direction of the first chamber (11).

4. Flow control device according to claim 2 or 3, wherein said pre-tensioning means is provided with two or more protuberances (61, 61′, 62I, 62II, 62III, 62IV, 62V, 62V) which extend radially from the membrane.

5. Flow control device according to claim 4, wherein said protuberances are arranged rotationally and symmetrically at a regular angular distance from one another.

6. Flow control device according to any one of the preceding claims, wherein said sealing surface comprises a protuberance (15, 16) formed on an inner shell of the tube element (14) which extends concentrically into the tube element.

7. Flow control device according to any of the preceding claims, wherein the actuator element (3) is connected integrally to the valve (4), and/or wherein said actuator element and said valve are composed of a single integrated component.

8. Flow control device according to any of the preceding claims, wherein said actuator element is provided near to an outermost edge with hook means (19), which are arranged to act cooperatively with a rim (25) formed on the flow control device for the detachable attachment of said actuator element to the flow control device.

9. Actuator element for a flow control device according to claim 1-10, wherein said actuator element comprises a membrane (10) and a tube element (14) extending upwardly, wherein said tube element is provided on an inner shell thereof with at least two sealing surfaces (15, 16) arranged at an axial distance from one another.

10. Actuator element according to claim 9, wherein said sealing surface comprises a protuberance (15, 16) formed on an inner shell of the tube element.

11. Actuator element according to claim 10, wherein the protuberance extends concentrically into the tube element.

12. Actuator element according to any of the claims 9-11, wherein the actuator element comprises a valve (4).

13. Actuator element according to claim 12, wherein the actuator element is provided with connecting means (6, 6′), which connect said actuator element with said valve.

14. Actuator element according to claim 13, wherein said membrane, said tube element, said connecting means and said valve are integrally connected with one another, and/or are composed of a single integrated component.
